(19) United States
(12) Patent Application Publication
(10) Pub. No.: US 2017/0355298 A1
(43) Pub. Date: Dec. 14, 2017

(54) REDUCTION GEAR BOX FOR A CHAIN BINDER

(71) Applicant: JODY L. CAHALL, DENTON, MD (US)

(72) Inventor: JODY L. CAHALL, DENTON, MD (US)

(21) Appl. No.: 15/179,907

(22) Filed: Jun. 10, 2016

(51) Int. Cl. B60P 7/08; F16H 57/021; F16H 1/20

(52) U.S. Cl. CPC B60P 7/0853; F16H 1/203; F16H 57/021; F16H 2057/0213; F16H 2057/0216

(57) ABSTRACT

The reduction gear box for a chain binder generally includes a housing member, a nozzle on the housing member to which a power tool may be connected, and an opening in the housing member within which the shaft portion of a chain binder may extend. The housing member includes a worm gear assembly and a main gear assembly therein. The worm gear assembly is in communication with the main gear assembly such that rotation of the worm gear assembly causes the main gear assembly also to rotate. In use, a shaft portion of a chain binder can be positioned within the housing opening and in communication with the main gear assembly. The power tool can be operated to rotate the worm gear assembly, and thereby effectuate rotation of the main gear assembly to extend or retract the chain binder in communication therewith.

### BACKGROUND OF THE INVENTION

### 1. Field of the Invention

The present invention relates to a gear reduction system, and more particularly, to a power driven gear reduction system configured for use with a chain binder, for facilitating efficiency and ease in extending and retracting the chain binder.

### 2. Description of the Related Art

Chain binders, also known as ratchet binders, are generally used in the trucking industry to secure loads for transporting. Most binding systems connect to a chain or strap that engages with the cargo. The conventional process of binding a load requires that the user first extend the binder, then hook the binder to a chain or strap engaged with the load. Thereafter, the user retracts the binder using a lever to tighten the straps. Rotating the lever causes one or more binder shaft members to rotate and pull the straps and/or chains in towards the binder, thereby tightening the load to a surface.

One disadvantage of the conventional binding system is that a kink in the chain or a wedge can break loose as the binder shaft runs out of threads. Additionally, the manual labor used to tighten the load with the lever can be time consuming and labor intensive. It is therefore advantageous to reduce the time and manual effort typically expended for ratcheting the binder.

Accordingly, a binding system that requires minimal operator effort is desired.

### SUMMARY OF THE INVENTION

The reduction gear box for a chain binder generally includes a housing member, a nozzle on the housing member to which a power tool may be connected, and an opening in the housing member within which the shaft of a chain binder may extend. The housing member includes a worm gear assembly and a main gear assembly therein. The worm gear assembly is in communication with the main gear assembly such that rotation of the worm gear assembly causes the main gear assembly also to rotate. In use, a shaft portion of a chain binder can be positioned within the housing opening, in communication with the main gear assembly. The power tool can be operated to rotate the worm gear assembly, and thereby effectuate rotation of the main gear assembly to extend or retract the chain binder in communication therewith.

These and other features of the present invention will become readily apparent upon further review of the following specification and drawings.

### BRIEF DESCRIPTION OF THE DRAWINGS

FIG. 1 is environmental perspective view of a reduction gear box for a chain binder.

FIG. 2 is a perspective view of the reduction gear box for a chain binder.

FIG. 3 is a perspective sectional view of the reduction gear box for a chain binder of FIG. 2, illustrating gear and shaft components.

FIG. 4 is a side view of the reduction gear box for a chain binder, illustrating a chain binder operatively in communication with the reduction gear box for a chain binder.

### DETAILED DESCRIPTION OF THE PREFERRED EMBODIMENTS

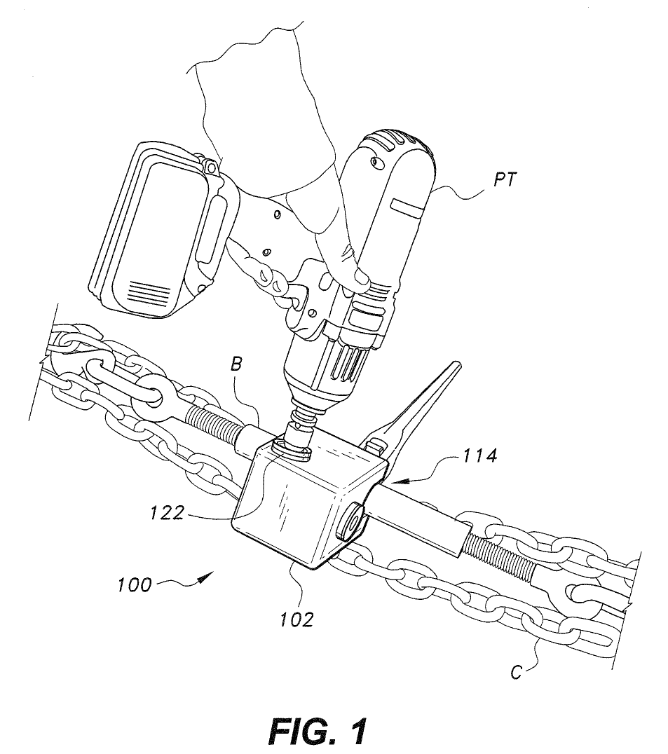

Referring to FIGS. 1-4, there is shown a reduction gear box for a chain binder, generally referred to as 100. As illustrated the reduction gear box for a chain binder 100 is configured for operating a conventional chain binder B in conjunction with a power tool PT. The reduction gear box for a chain binder 100 generally includes a housing member 102, a nozzle 122 on the housing member to which the power tool may be connected, and an opening 114 in the housing member 102 through which the shaft of a binder B may extend.

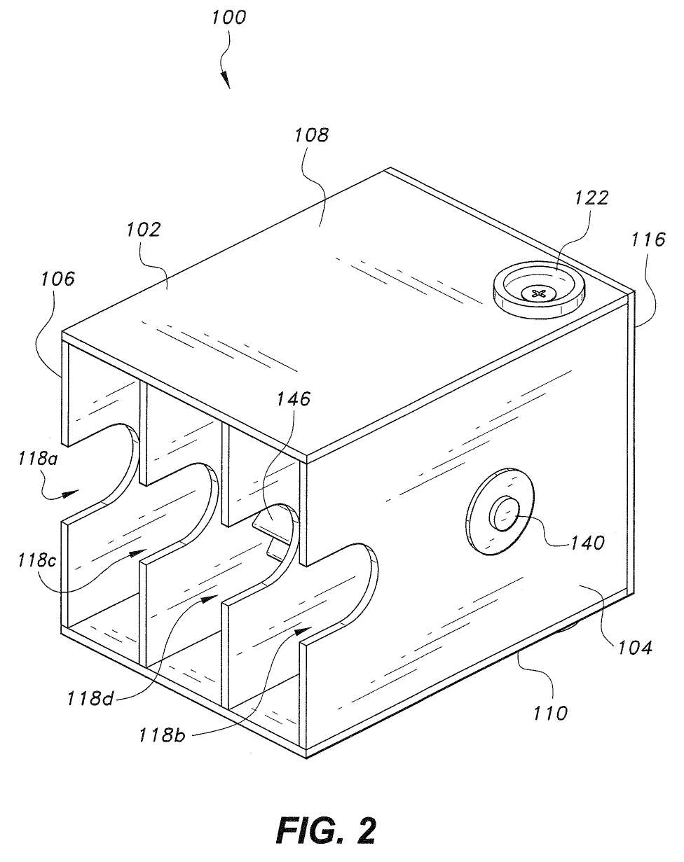

As illustrated in FIG. 2, the housing member 102 may have a generally rectangular-shaped configuration. The housing member 102 generally includes a first side wall member 104, an opposing second side wall member 106, a third or top wall member 108 extending between the first side wall member 104 and the second side wall member 106, a fourth or bottom wall member 110 provided opposite the third or top wall member 108 and extending between the first side wall member 104 and the second side wall member 106.

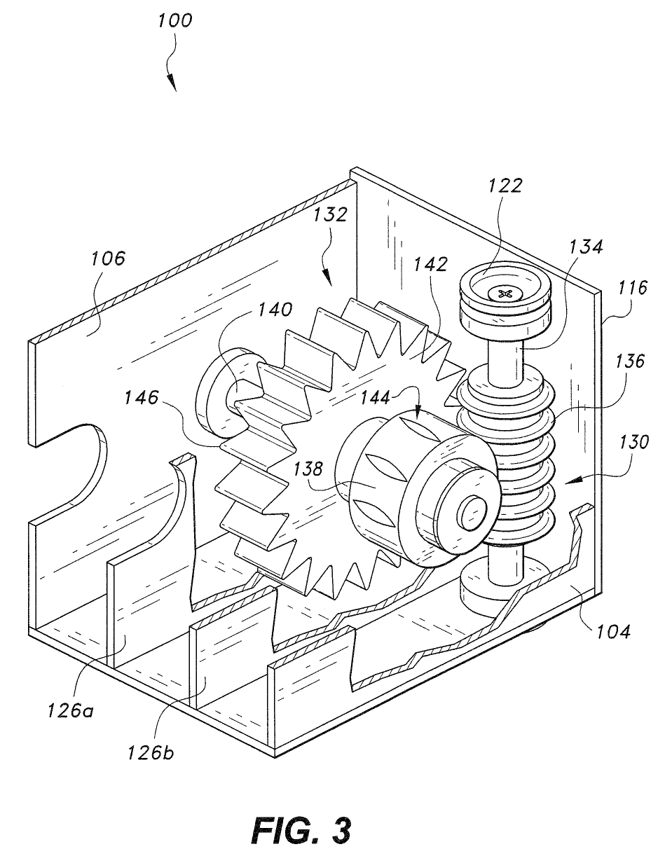

A fifth side wall member 116 extends between the first and second wall members 104, 106, as well as the third and fourth side wall members 108, 110. The opening 114 is opposite the fifth side wall member 116, as shown in FIG. 3. The nozzle 122 is provided at the third or top wall member 108. As illustrated in FIG. 2, the nozzle 122 is configured to receive the power tool PT, such as an impact gun, or high powered drill.

The first and second side wall members, 104, 106 each have a generally arcuate-shaped groove, 118a and 118b respectively, at one end. The grooves 118a, 118b are in alignment with each other and are configured to provide a support surface for the shaft of the binder B. As illustrated, the housing member 102 may further include interior wall members, e.g., interior support wall members 126a, 126b, respectively, inside the housing member 102, generally parallel to the first side wall member 104 and second side wall member 106. The interior support wall members 126a, 126b may include respective grooves 118c, 118d, in alignment with grooves, 118a and 118b, to provide further support for the shaft of the binder B.

As shown in FIG. 3, the gear reduction system 100 generally includes a first gear assembly 130 and a second or main gear assembly 132. The first gear assembly 130 can be a worm gear assembly 130, including a worm gear 134, which as illustrated, extends generally between the third and fourth wall members 108 and 110 and includes a plurality of teeth 136. The nozzle 122 can be in communication with the worm gear 134 such that the worm gear 134 rotates when the nozzle 122 is rotated by a power tool PT.

As illustrated in FIG. 3, the main gear assembly 132 includes a main shaft member 140 which extends generally between the first side wall member 104 and the second side wall member 106. The main shaft member 140 includes a gear member 142 and a wheel 138 fixedly connected to the main shaft member 140. The gear member 142 includes a plurality of gear teeth 146 configured to engage the binder gear BG of a chain binder. The wheel member 138 includes a plurality of grooves 144 configured to engage the teeth 136 of the worm gear 134. The shaft 140 extends between the first side wall member 104 and second side wall member 106 in a direction generally perpendicular to the worm gear 134.

The worm gear 134 is positioned proximate the second gear assembly 132 such that the teeth 136 operatively engage the grooves 144 of the wheel 138. The wheel 138 is fixedly attached to the main shaft 140, such that rotation of the wheel 138 initiated by rotation of the worm gear 134 rotates the shaft member 140. Thus, as the worm gear assembly 130 is activated by the power tool PT, the worm gear assembly 130 operatively engages the main gear assembly 132 transferring rotational power from the power tool to the shaft member 134 and ultimately to the first gear member 142.

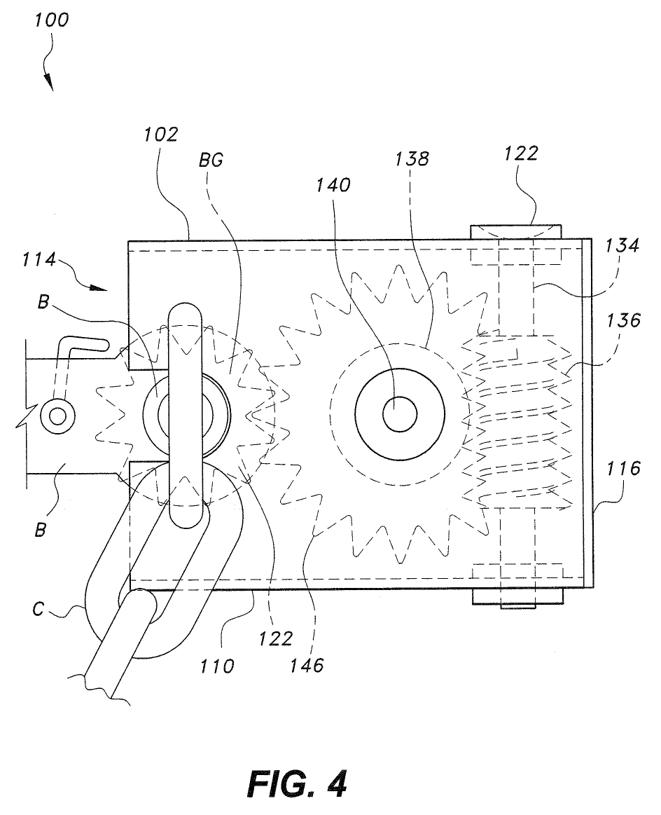

Referring to FIGS. 1 and 4, in operation, a user can connect a power tool PT to the nozzle 122 provided external to the housing 102. As the power tool PT rotates, the nozzle 122 and the connected worm gear 134 rotate, which causes rotation of the wheel 138 and the connected second shaft member 140 and first gear member 142. In this manner, a rotation force is ultimately exerted on the engaged binder gear BG. Rotation of the binder gear BG rotates the connected threaded shaft member of the binder B, thereby pulling the chain or strap connected thereto. Accordingly, the reduction gear box for chain binders can be used to extend and retract the chain binder B without requiring the use of the conventional lever on the binder B.

It is to be understood that the present invention is not limited to the embodiments described above, but encompasses any and all embodiments within the scope of the following claims.

I claim:

1. A reduction gear box for a chain binder, comprising:
a housing having an opening;
a worm gear in the housing;
a nozzle, a portion of the nozzle extending exterior to the housing and a remaining portion connected to the worm gear in the housing;
a main shaft provided in the housing;
a wheel member fixedly attached to the main shaft and in communication with the worm gear such that rotation of the worm gear rotates the wheel member; and
a second gear member connected to the main shaft and configured to engage the chain binder through the opening.

2. The gear reduction system of claim 1, wherein the worm gear is positioned generally perpendicular to the main shaft.

3. The gear reduction system of claim 2, wherein the wheel member includes grooves configured to engage the worm gear.

4. The gear reduction system of claim 1, wherein the housing has a first side wall member and a second side wall member, the first side wall member and the second side wall member each including a groove for supporting a shaft portion of the chain binder therein.

5. The gear reduction system of claim 4, further comprising one or more interior wall members in the housing, parallel to the first side wall member and the second side wall member, each of the one or more interior wall members including a groove in alignment with the grooves of the first side wall member and the second side wall member.

6. The gear reduction system of claim 5, wherein the housing has a top wall member and an opposing bottom wall member, and the worm gear extends between and connects the top wall member and the bottom wall member and the main shaft extends between the first side wall member and the second side wall member in a direction perpendicular to the worm gear.

7. A reduction gear box for a chain binder, comprising:
a generally rectangular housing having an opening on one side and support grooves defined in side walls of the housing for supporting a shaft portion of the chain binder;
a worm gear provided in the housing;
a nozzle, a portion of the nozzle extending exterior to the housing and a remaining portion connected to the worm gear in the housing;
a main shaft provided in the housing, the main shaft being perpendicular to the worm gear;
a wheel member fixedly attached to the main shaft and in communication with the worm gear such that rotation of the worm gear rotates the wheel member; and
a second gear member connected to the main shaft and configured to engage the chain binder through the opening.
